(19) United States
(12) Patent Application Publication
(10) Pub. No.: US 2019/0100169 A1
(43) Pub. Date: Apr. 4, 2019

(54) WIPER AND METHOD OF FORMING THE SAME

(71) Applicant: Ford Global Technologies, LLC, Dearborn, MI (US)

(72) Inventors: Paul Kenneth Dellock, Northville, MI (US); Jose Garcia Crespo, Bloomfield Township, MI (US); Stuart C. Salter, White Lake, MI (US); Richard Gall, Ann Arbor, MI (US); Talat Karmo, Waterford, MI (US)

(21) Appl. No.: 15/723,220

(22) Filed: Oct. 3, 2017

(51) Int. Cl. B60S 1/38; B29C 47/06

(52) U.S. Cl. CPC B60S 1/3805; B60S 2001/3829; B60S 2001/3898; B29C 47/06

(57) ABSTRACT

A wiper for a motor vehicle according to an exemplary aspect of the present disclosure includes, among other things, a blade having an inner portion and an outer portion. The inner portion has an increased thermal conductivity relative to the outer portion, and the outer portion is softer than the inner portion. A method is also disclosed.

### BACKGROUND

This disclosure relates to a wiper, such as a windshield wiper, for a motor vehicle and a method of forming the same.

### BACKGROUND

Motor vehicles are known to have a windshield wiper configured to remove rain, snow, ice, and other debris from the windshield of the vehicle. In addition to a windshield wiper, some vehicles include features configured to reduce the buildup of ice and snow on the windshield. For example, most vehicles include windshield defrosters and windshield washer nozzles, which are configured to spray windshield washer fluid on the windshield. Heated windshield wipers are also known, although they are typically not standard vehicle features. Rather, they are more commonly sold as aftermarket accessories.

### SUMMARY

A wiper for a motor vehicle according to an exemplary aspect of the present disclosure includes, among other things, a blade having an inner portion and an outer portion. The inner portion has an increased thermal conductivity relative to the outer portion, and the outer portion is softer than the inner portion.

In a further non-limiting embodiment of the foregoing wiper, the inner portion is made of silicone and carbon nanotubes.

In a further non-limiting embodiment of any of the foregoing wipers, the inner portion has a conductivity of about 0.9 watts per meter-kelvin.

In a further non-limiting embodiment of any of the foregoing wipers, the inner portion has a volume resistivity of less than 100 ohm centimeters.

In a further non-limiting embodiment of any of the foregoing wipers, the outer portion is made of silicone.

In a further non-limiting embodiment of any of the foregoing wipers, the outer portion has a Shore hardness between about 50A and 80A.

In a further non-limiting embodiment of any of the foregoing wipers, the blade includes a heater element within the inner portion.

In a further non-limiting embodiment of any of the foregoing wipers, the heater element includes a strip of resistive material.

In a further non-limiting embodiment of any of the foregoing wipers, the resistive material is nichrome.

In a further non-limiting embodiment of any of the foregoing wipers, the wiper further includes a beam supporting the blade and spanning substantially the entire length of the blade.

In a further non-limiting embodiment of any of the foregoing wipers, the wiper further includes a cover over the beam, and a power wire between the cover and the beam. The power wire is configured to provide power to heat the blade.

In a further non-limiting embodiment of any of the foregoing wipers, the power wire is electrically coupled to a controller and a power supply.

In a further non-limiting embodiment of any of the foregoing wipers, the power wire pierces through an outer skin of the silicone material of the blade.

In a further non-limiting embodiment of any of the foregoing wipers, the cover includes first and second walls converging at a nose, and, when viewed from the exterior of the cover, the first and second walls are concave.

In a further non-limiting embodiment of any of the foregoing wipers, the outer portion of the blade is coated with a non-stick coating.

In a further non-limiting embodiment of any of the foregoing wipers, the wiper is a windshield wiper.

A method according to an exemplary aspect of the present disclosure includes, among other things, forming a blade of a wiper by co-extruding a first material and a second material, the first material being more thermally conductive than the second material, and the second material being softer than the first material.

In a further non-limiting embodiment of the foregoing method, the first material includes silicone and carbon nanotubes, and the second material includes silicone.

In a further non-limiting embodiment of any of the foregoing methods, the forming step includes feeding a heater element such that the heater element is encased within the first material.

In a further non-limiting embodiment of any of the foregoing methods, the blade is extruded together with a base, the base made of a third material.

### BRIEF DESCRIPTION OF THE DRAWINGS

FIG. 1 is a partial front view of a motor vehicle including a first and second windshield wipers.

FIG. 2 illustrates an example wiper.

FIG. 3 is a cross-sectional view of the wiper taken along line 3-3.

FIG. 4 is a cross-sectional view of the wiper taken along line 4-4.

FIG. 5 is a view of another example wiper taken along line 4-4.

FIG. 6 schematically illustrates a first system for making an example wiper.

FIG. 7 schematically illustrates a second system for making an example wiper.

### DETAILED DESCRIPTION

This disclosure relates to a wiper for a motor vehicle and a method of forming the same. In this disclosure, the wiper includes a blade with an inner portion and an outer portion. The inner portion has an increased thermal conductivity relative to the outer portion, and the outer portion is softer than the inner portion. The inner portion is configured to conduct heat throughout the blade, including to the tip of the blade, while the outer portion provides an effective interface between the blade and a window of a motor vehicle.

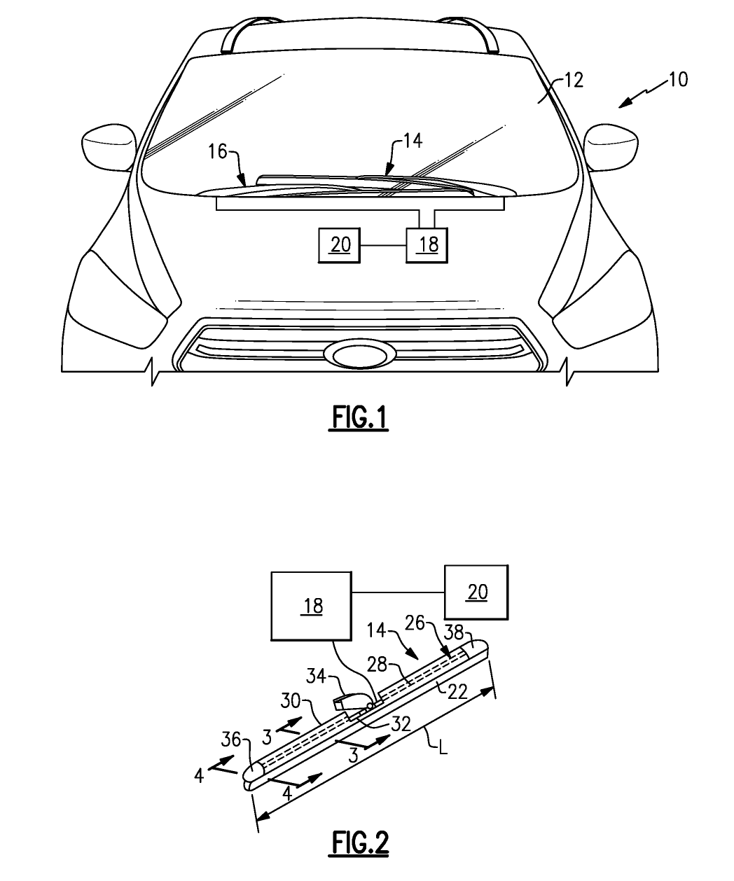

Referring to the drawings, FIG. 1 is a partial front view of a motor vehicle 10, which is shown as a sport utility vehicle (SUV). While FIG. 1 shows an SUV, this disclosure is not limited to SUVs and extends to other vehicles, including cars, minivans, trucks, and hatchbacks, among others. The vehicle 10 includes a windshield 12, or windscreen, and first and second wipers 14, 16 configured to traverse the windshield 12 to wipe the windshield 12, thereby removing rain, snow, ice, and other debris from the windshield 12. While two wipers 14, 16 are illustrated in FIG. 1, it should be understood that this disclosure extends to vehicles with one or more wipers. Further, while the wipers 14, 16 are illustrated relative to a windshield 12, this disclosure extends to wipers for other windows of a motor vehicle, such as rear wipers. Further, it should be understood that certain aspects of the wipers 14, 16, and the associated systems for forming the same, are exaggerated in the Figures for purposes of illustration only.

In this disclosure, the first and second wipers 14, 16 are heated wipers, meaning they are configured to be heated to remove snow and ice adjacent the first and second wipers 14, 16, which helps clear the windshield in cold weather conditions. As such, the first and second wipers 14, 16 are electrically coupled to a controller 18, which in turn is electrically coupled to a power supply 20. The power supply 20 is provided by a battery of the vehicle 10, in one example, such as a 12 Volt battery of the vehicle 10.

The controller 18 is shown schematically in FIG. 1. It should be understood that the controller 18 could be part of an overall vehicle control module, such as a vehicle system controller (VSC), or could alternatively be a stand-alone controller separate from the VSC. Further, the controller 18 may be programmed with executable instructions for interfacing with and operating the various components of the vehicle 10. The controller 18 additionally includes a processing unit and non-transitory memory for executing the various control strategies and modes of the vehicle system. While the controller 18 and power supply 20 are shown separately, the controller and power supply could be integrated into a combined unit in some examples.

FIG. 2 illustrates the wiper 14, controller 18, and power supply 20, without the remainder of the vehicle 10 for ease of reference. While not shown in FIG. 2, it should be understood that the wiper 16 is arranged in substantially the same way as the wiper 14. The wiper 14 spans along a length L, and has a blade 22 spanning substantially the entire length L. The blade 22 is supported by a base 23 (FIG. 3) which projects from a beam 24 (FIG. 3). The base 23 and beam 24 also span substantially the entire length L. While this disclosure extends to other material types, the base 23 may be made of a relatively stiff silicone material, such as a silicone having a Shore hardness of within a range of about 80A to 90A, and the beam 24 may be made of a steel or stainless steel material.

The beam 24 is covered by a cover 26. Between the beam 24 and the cover 26, a power wire 28 (shown partially in phantom in FIG. 2) extends along the length L of the wiper 14, and supplies power from the power supply 20 to the blade 22 when activated by the controller 18, thereby heating the blade 22.

The cover 26 may be provided in one or more pieces. In this example, the cover 26 includes a main cover 30 extending along a majority of the length L of the wiper 14. At a midpoint of the main cover 30, the cover 26 includes a cutout 32 to accommodate an attachment 34, which is configured to attach the wiper 14 to a wiper arm. The cover 26 also includes first and second end caps 36, 38 at opposite ends of the wiper 14.

FIG. 3 is a cross-sectional view of the wiper 14, taken along line 3-3 from FIG. 2. FIG. 3 illustrates the arrangement of the wiper 14, including the detail of the blade 22. The blade 22 includes at least two portions, each having a different chemical composition. For instance, the blade 22 includes an inner portion 40 and an outer portion 42. The outer portion 42 completely encapsulates the inner portion 40 in this example. In other examples, the outer portion 42 may encapsulate a portion of the inner portion 40. In this example, the inner portion 40 is substantially triangle-shaped in cross-section, and tapers in width toward the windshield 12. The outer portion 42 has a substantially uniform thickness around the inner portion 40.

Providing the blade 22 with at least two different portions allows the blade 22 to effectively conduct heat, even to a tip 44 of the blade 22, while also maintaining sufficient contact with the windshield 12. Accordingly, the inner portion 40 has an increased thermal conductivity relative to the outer portion 42, and the outer portion 42 is softer than the inner portion 40. The disclosed arrangement allows the blade 22 to reach a relatively high temperature more quickly, while remaining hotter during operation, when compared to known heated windshield wipers.

In one example, the inner portion 40 is made of a combination of silicone and carbon nanotubes. Reference to silicone in this disclosure refers to all forms of silicone, including silicone rubber. In one particular example, the inner portion 40 is made of silicone that has been modified by integrating a relatively small amount of carbon nanotubes into the silicone material. Carbon nanotubes are known to have a relatively high thermal conductivity, whereas silicone is known to have a relatively high thermal resistivity. In one example, the carbon nanotubes themselves are multiwall carbon nanotubes and exhibit a thermal conductivity of about 2,000 watts per meter-kelvin, but also have a hardness approaching the hardness of diamond. Without the carbon nanotubes, silicone has a relatively low thermal conductivity, on the order of 0.2 watts per meter-kelvin. With the carbon nanotubes, the inner portion 40 has a conductivity of about 0.9 watts per meter-kelvin, and a volume resistivity of less than 10² ohm centimeters. In one particular example, the inner portion 40 includes 2% multiwall carbon nanotubes by weight, and in that example the inner portion 40 has a thermal conductivity of 0.92 watts per meter-kelvin. The carbon nanotubes can be provided by any type of multi-walled carbon nanotube, including vapor-grown carbon nanofibers as one example, or another type of suitable carbon nanotube. Integrating carbon nanotubes into the inner portion 40 gives the inner portion 40 properties close to those of a semiconductor. The increased thermal conductivity of the inner portion 40 disperses heat throughout the blade 22, including to the tip 44, which increases the ease of snow and ice removal.

While the inner portion 40 exhibits an increased thermal conductivity, the inner portion 40 is also relatively hard, which may not ideal for contacting the windshield 12. Accordingly, the outer portion 42 is provided by a relatively soft material, which in this example is silicone. The outer portion 42 is entirely silicone and does not include carbon nanotubes in this example. The outer portion 42 exhibits a Shore hardness between about 50A and 80A, which is softer than the inner portion 40. In one particular example, the outer portion 42 is provided by a medium thermal carbon black material, such as Thermax® N990, manufactured by Cancarb Limited. The softer material of the outer portion 42 provides an effective interface between the blade 22 and the windshield 12, and specifically mitigates a phenomenon known as blade chatter, which is the rapid, undesirable movement of a wiper blade relative to a windshield.

Optionally, the outer portion 42 of the blade 22 is at least partially coated with a non-stick coating 46. The non-stick coating 46 can be provided by a non-stick material, such as polytetrafluoroethylene (PTFE), more commonly referred to as Teflon®. In this example, the non-stick coating 46 covers the tip 44 and a portion of the exterior of the outer portion 42 adjacent the tip 44.

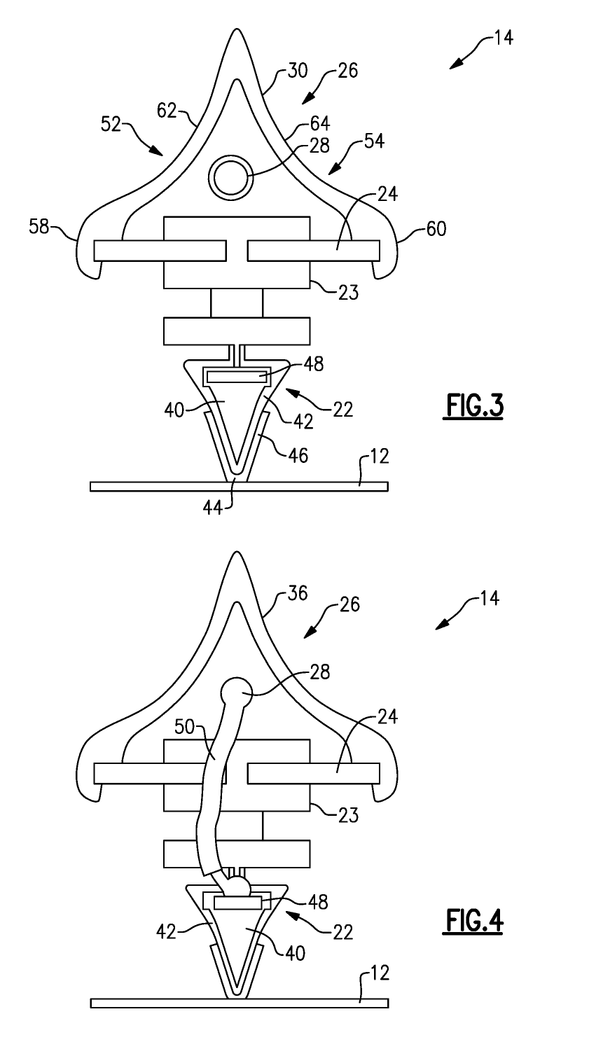

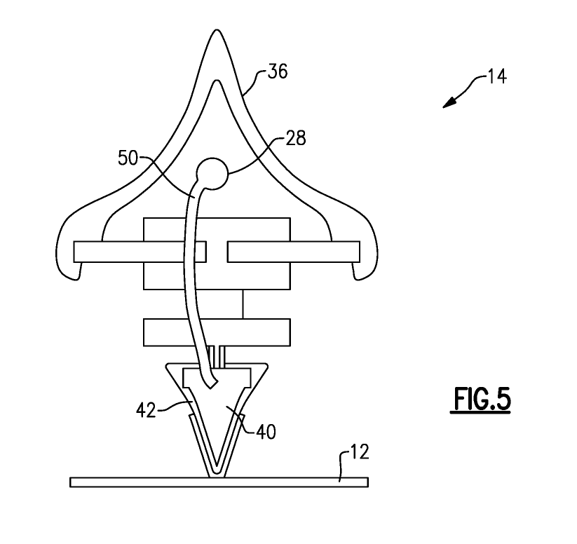

In the embodiment of FIG. 3, the blade 22 includes a heater element 48 within the inner portion 40. The heater element 48 is electrically coupled to the power wire 28 by way of a lead 50 (FIG. 4). In this example, the lead 50 extends between the power wire 28 and the heater element 48 beneath the first end cap 36, as shown in FIG. 4. While not illustrated, it should be understood that there is a similar lead beneath the second end cap 38 between the power wire and the heater element 48. One of the leads would provide a positive terminal, and another would provide a negative terminal. In this way, current flows through the heater element 48, which generates heat that is conducted within the blade 22 by way of the inner portion 40.

The heater element 48 may be any known type of heater element, including a strip of resistive material, such as a resistive wire, as one example. In one particular example, the heater element 48 is made of an alloy of Nickel and chrome, such as nichrome, and provides a resistance of about 0.12 ohms-meter. The heater element 48 may be generally rectangular in cross-section. In one example, the heater element 48 is about 0.8 mm thick (e.g., in the up-and-down direction, relative to FIG. 3) and about 8 mm wide (e.g., in the left-to-right direction, relative to FIG. 3). The heater element 48 exhibits a relatively increased lateral stiffness and increased vertical flexibility, and as such the heater element 48 withstands the forces that typically arise in the environment of a windshield wiper.

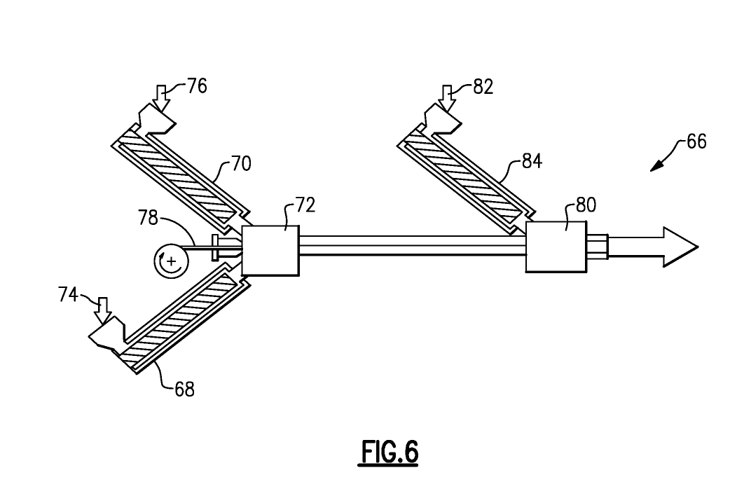

While a heater element 48 is illustrated in the embodiment of FIGS. 3 and 4, this disclosure extends to wipers that do not include heater elements. For example, in the embodiment of FIG. 5, the wiper 14 includes a power wire 28 that directly pierces through the outer skin of the silicone material of the blade 22. Specifically, the power wire 28 is coupled directly to the inner portion 40 of the blade 22 by way of the lead 50. The blade 22 does not include a heater element. Current is conducted between the ends of the blade 22 by the inner portion 40.

Turning back to FIG. 3, the cover 26 is aerodynamically shaped. Such a shape reduces the effect of wind drag brought about by the increased size of the wiper 14 needed to accommodate the power wire 28, for example. In this example, the main cover 30 includes first and second walls 52, 54 that extend from the beam 24 to a nose 56. Adjacent the beam 24, the walls 52, 54 include convex portions 58, 60, which are convex when viewed from an exterior of the wiper 14. The convex portions 58, 60 include recesses on an interior surface thereof to provide a connection with the beam 24. In one example, the connection is a snap-fit connection, although other types of connections come within the scope of this disclosure.

Between the convex portions 58, 60, and the nose 56, each wall 52, 54 includes a concave portion 62, 64, which are concave when viewed from an exterior of the wiper 14. The concave portions 62, 64 span a majority of the height (e.g., the up-and-down direction, relative to FIG. 3) of the cover 26. The concave portions 62, 64, converge at the nose 56. In one example, the nose 56 is pointed. In another example, the nose 56 is rounded. While the above discussion is relative to the main cover 30, it should be understood that the caps 36, 38 may be shaped the same way as the main cover 30.

In operation, the controller 18 regulates the temperature of the blade 22 by adjusting the current flowing through the heater element 48, if present, or the inner portion 40, to achieve a target temperature. In one example, the target temperature is about 100° C. (about 212° F.). The controller 18 may include a pulse width modulation (PWM) circuit. Further, the controller 18 may be electrically coupled to a sensor, such as a thermistor, embedded in the blade 22, which provides the controller with a signal indicative of the temperature of the blade 22 and may prevent the blade 22 from overheating. The controller 18 may also make adjustments based on the outside temperature. Further still, the controller 18 is operable to detect a short circuit, and to shut down if a short is detected. While example control strategies are discussed herein, it should be understood that this disclosure extends to other controllers and control strategies.

Certain portions of the wiper 14 can be formed by extrusion. In one example of this disclosure, the blade 22 is formed by co-extruding a first material and a second material over the first material. The first material, in one example, provides the inner portion 40 of the blade 22, which is more thermally conductive than the second material, as noted above. The second material provides the outer portion 42, which is softer than the inner portion 40.

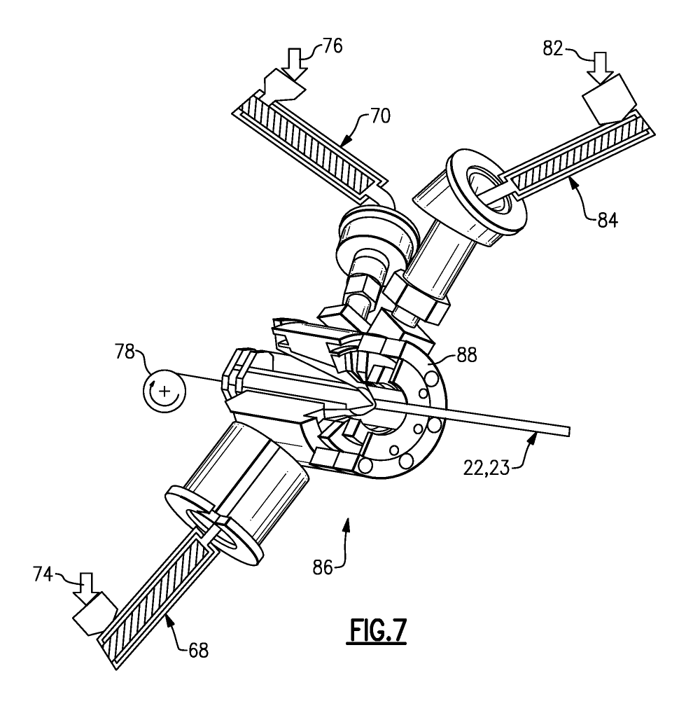

FIG. 6 schematically illustrates an example system for forming the blade 22. With reference to FIG. 6, an example system 66 includes a first extrusion element 68 and a second extrusion element 70, each configured to feed material to a first die 72. The extrusion elements 68, 70 are known extrusion elements, including hoppers, barrels, screws, etc. The first extrusion element 68 feeds a first material 74 to the first die 72. The first material 74 ultimately becomes the inner portion 40 of the blade 22. The second extrusion element 70 feeds a second material 76 to the first die 72, where the second material 76 is co-extruded with the first material 74 to provide the base 23. Alternatively, the second material 76 becomes the outer portion 42.

When a heater element 48 is present, such as in the embodiment of FIGS. 3 and 4, resistive material 78 is also fed through the first die 72. Again, the resistive material 78 may be nichrome.

Downstream of the first die 72, the system 66 includes a second die 80, which receives a third material 82 from a third extrusion element 84. There, the co-extrusion from the first die 72 is itself co-extruded with the third material 82. The third material ultimately provides the outer portion 42, in one example. Alternatively, the third material 82 can become the base 23. While a particular manufacturing process has been shown and described relative to FIG. 6, this disclosure contemplates other manufacturing processes.

One example alternate manufacturing process is shown relative to the system 86 of FIG. 7. In FIG. 7, the first, second, and third extrusion elements 68, 70, 84 feed their respective material 74, 76, 82 to a single die 88. When a heater element is present, resistive material 78 is also fed to the die 88. The die 88 is arranged such that the inner portion 40, outer portion 42, base 23, and resistive material 78 (if present) is fed through the die 88 to produce the blade 22 and base 23. Again, while FIG. 7 shown an example system for forming the blade 22 (and base 23), this disclosure extends to other systems and manufacturing techniques.

While silicone is specifically contemplated above as a material used to form the inner portion 40 and the outer portion 42, as examples, this disclosure extends to other materials. For example, natural rubber may be used as a replacement for silicone in one or more of the components of the wipers 14, 16.

It should be understood that terms such as “about,” “substantially,” and “generally” are not intended to be boundaryless terms, and should be interpreted consistent with the way one skilled in the art would interpret those terms.

Although the different examples have the specific components shown in the illustrations, embodiments of this disclosure are not limited to those particular combinations. It is possible to use some of the components or features from one of the examples in combination with features or components from another one of the examples.

One of ordinary skill in this art would understand that the above-described embodiments are exemplary and non-limiting. That is, modifications of this disclosure would come within the scope of the claims. Accordingly, the following claims should be studied to determine their true scope and content.

1. A wiper for a motor vehicle, comprising:
a blade including an inner portion and an outer portion, wherein the inner portion has an increased thermal conductivity relative to the outer portion, and wherein the outer portion is softer than the inner portion.

2. The wiper as recited in claim 1, wherein the inner portion is made of silicone and carbon nanotubes.

3. The wiper as recited in claim 2, wherein the inner portion has a conductivity of about 0.9 watts per meter-kelvin.

4. The wiper as recited in claim 3, wherein the inner portion has a volume resistivity of less than 100 ohm centimeters.

5. The wiper as recited in claim 1, wherein the outer portion is made of silicone.

6. The wiper as recited in claim 5, wherein the outer portion has a Shore hardness between about 50A and 80A.

7. The wiper as recited in claim 1, wherein the blade includes a heater element within the inner portion.

8. The wiper as recited in claim 7, wherein the heater element includes a strip of resistive material.

9. The wiper as recited in claim 8, wherein the resistive material is nichrome.

10. The wiper as recited in claim 1, further comprising a beam supporting the blade and spanning substantially the entire length of the blade.

11. The wiper as recited in claim 10, further comprising a cover over the beam, and a power wire between the cover and the beam, the power wire configured to provide power to heat the blade.

12. The wiper as recited in claim 11, wherein the power wire is electrically coupled to a controller and a power supply.

13. The motor vehicle as recited in claim 11, wherein the power wire pierces through an outer skin of the silicone material of the blade.

14. The wiper as recited in claim 11, wherein the cover includes first and second walls converging at a nose, and wherein, when viewed from the exterior of the cover, the first and second walls are concave.

15. The wiper as recited in claim 1, wherein the outer portion of the blade is coated with a non-stick coating.

16. The wiper as recited in claim 1, wherein the wiper is a windshield wiper.

17. A method, comprising:
forming a blade of a wiper by co-extruding a first material and a second material, the first material being more thermally conductive than the second material, and the second material being softer than the first material.

18. The method as recited in claim 17, wherein the first material includes silicone and carbon nanotubes, and wherein the second material includes silicone.

19. The method as recited in claim 18, wherein forming step includes feeding a heater element such that the heater element is encased within the first material.

20. The method as recited in claim 19, wherein the blade is extruded together with a base, the base made of a third material.
